(19) United States
(12) Patent Application Publication
(10) Pub. No.: US 2006/0163003 A1
(43) Pub. Date: Jul. 27, 2006

(54) Ladder-mountable toolbox

(75) Inventor: John Wigstrom SR., Belle Chasse, LA (US)

Correspondence Address: KEATY PROFESSIONAL LAW CORPORATION;THOMAS S. KEATY, 2 CANAL STREET, 2140 WORLD TRADE CENTER, NEW ORLEANS, LA, 70130, US

(73) Assignee: WAS Designs, L.L.C.

(21) Appl. No.: 11/040,207

(22) Filed: Jan. 21, 2005

(51) Int. Cl. E06C 5/32

(52) U.S. Cl. 182/129

(57) ABSTRACT

A toolbox for use with a foldable stepladder has a housing and a top plate with a peripheral lip extending above the top plate for retaining objects placed on the top plate. The housing may have one enclosure or, a different embodiment, a pair of housing portions secured on opposite sides of the top plate. When the toolbox has two housing portions a central plate defining the top plate rests on a top step of a ladder. In the embodiment using one enclosure, the toolbox is hooked to an underside of an upper step and is positioned in a cantilevered fashion below the top step.

### BACKGROUND OF THE INVENTION

The present invention relates generally to ladder accessories, and more particularly to a toolbox configured for placing on a stepladder and adapted for holding auxiliary tools, implements, and working materials.

The stepladders are excessively used in various industries for supporting a worker at an elevated position. A-frame foldable ladders are used by construction workers, painters, electricians, gardeners and a multitude of other individuals who work on tasks requiring access to the elevate locations. The stepladders usually contain the top platform, or top step that is used for providing structural integrity to the ladder and is not used for stepping. When a user works at the top of the ladder, the user often finds that picking up extra supplies or tools from the ground level is time consuming and inefficient. The waste of time and energy is somewhat minimized if the user has a helper who is standing by to reach up and provide the necessary tools, paint brushes, paint buckets and the like to the person standing on top of the ladder. However, when such helper is not available, the user has no other alternative but to keep on returning to the ground for picking up the materials as the job progresses.

The present invention contemplates elimination of the drawbacks associated with using a conventional stepladder and providing a ladder accessory to hold tools, supplies, and other such materials easily accessible to a person working on the ladder.

### SUMMARY OF THE INVENTION

It is, therefore, an object of the present invention to provide a toolbox for use with a stepladder and, if desired, to be used independently of the ladder.

It is another object of the present invention to provide a toolbox, which can be easily transported to the location and installed on a stepladder in an easy and time efficient manner.

It is a further object of the present invention to provide a toolbox with a recessed cover that forms a platform for retaining accessories in an easily accessible manner for the user.

These and other objects of the present invention are achieved through a provision of a toolbox that is configured for placing on a stepladder, either on the top step or between the top step and the upper step. The toolbox has a housing means with a top plate, which is provided with a foldable carrying handle. The top plate is recessed in relation to a top edge of the housing means. A peripheral lip, or ledge is formed about the top edge of the housing means so as to retain objects on the top plate during use of the toolbox and prevent these objects rolling off.

In one of the embodiments, the housing means has a pair of open top housing portions secured to opposite sides of the top plate. The top plate in this embodiment is configured to rest on the top step of the ladder. The housing portions are suspended on both sides of the ladder providing compartment space for holding tools, brushes, paint cans, fasteners and the like.

In the second embodiment, the housing forms a box-like enclosure, where the top plate serves as a cover. A pair of grooves are formed in opposing side walls of the enclosure below the top edge, and the cover is slidably detachably engages in within the grooves. The second embodiment of the instant invention can be position between the top step and the upper step and hooks onto the upper step by a securing bracket attached to a back wall of the enclosure. The enclosure is cantilevered on the ladder when in working position, and the front end of the enclosure is oriented below the back end

### BRIEF DESCRIPTION OF THE DRAWINGS

Reference will now be made to the drawings, wherein like parts are designated by like numerals and wherein

FIG. 1 is a perspective view of the first embodiment of the toolbox in accordance with the present invention mounted on a stepladder.

FIG. 2 is a perspective view of the toolbox of the first embodiment of the present invention shown with an optional brush/tool tray.

FIG. 3 is a top view of the toolbox in accordance with the first embodiment of the present invention.

FIG. 4 is a left side view of the toolbox in accordance with the first embodiment of the present invention.

FIG. 5 is a front view of the toolbox of the first embodiment of the present invention.

FIG. 6 is a right side view of the toolbox in accordance with the first embodiment of the present invention.

FIG. 7 is a perspective view of the toolbox in accordance with the second embodiment of the present invention in the process of being positioned on the ladder.

FIG. 8 is a side view of the toolbox of the second embodiment of the present invention showing the toolbox in a working position.

FIG. 9 is a perspective view of the toolbox in accordance with the second embodiment of the present invention, with the cover closed.

FIG. 10 is a perspective view of the toolbox in accordance with the second embodiment of the present invention, with the cover partially removed.

FIG. 11 is a top view of the toolbox in accordance with the second embodiment of the present invention.

FIG. 12 is a left side view of the toolbox of the second embodiment of the present invention.

FIG. 13 is front view of the toolbox of the second embodiment of the present invention.

FIG. 14 is a right side view of the toolbox in accordance with the second embodiment of the present invention.

### DETAILED DESCRIPTION OF THE PREFERRED EMBODIMENTS

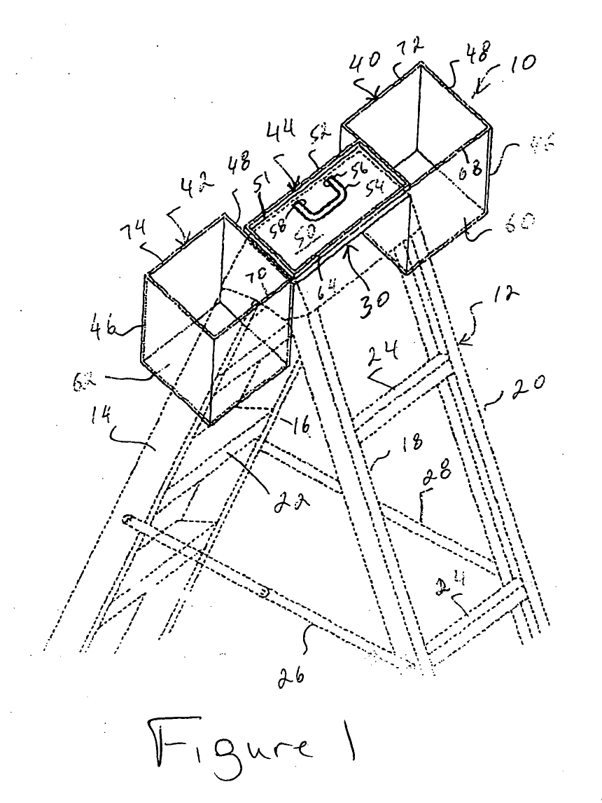

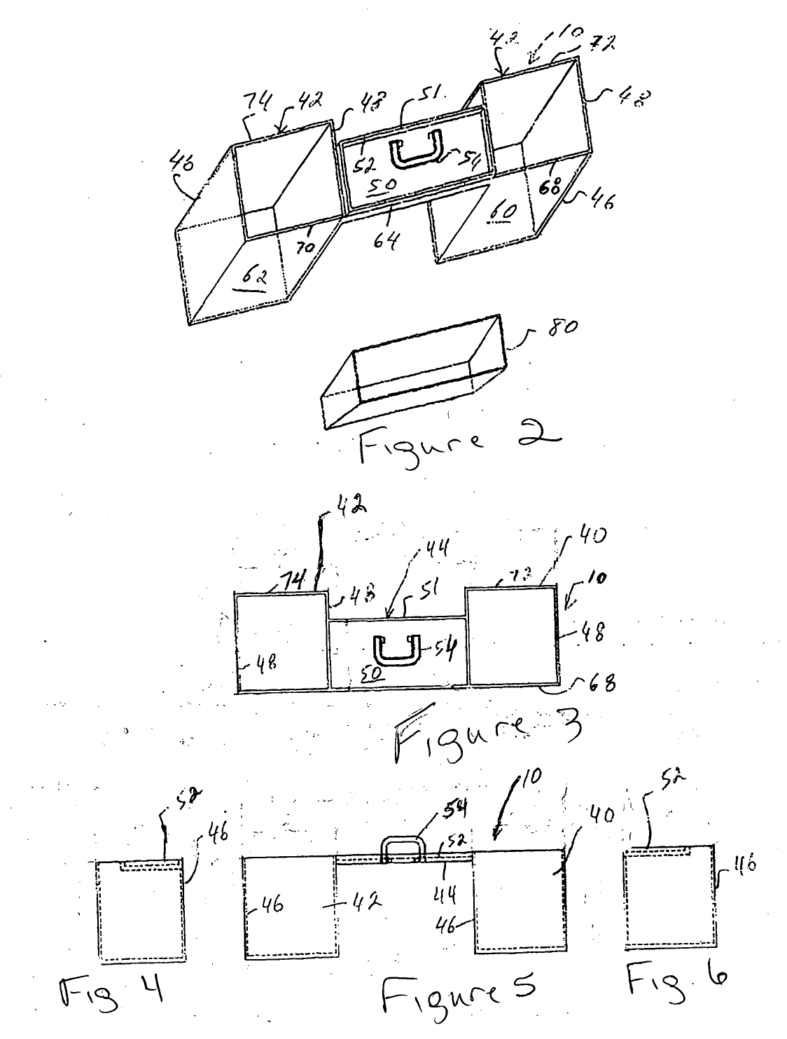

Turning now to the drawings in more detail, numeral 10 designates the toolbox in accordance with the first embodiment of the present invention. The tool box 10 is configured to be coupled to a conventional stepladder 12 to provide easy access of the person working at an elevated position on the ladder. The ladder 12 does not form a part of the present invention. Conventional stepladder 12, schematically shown in phantom lines in FIGS. 1, 7, and 8 comprises a pair of parallel spaced-apart front legs 14, 16 and a pair of parallel spaced-apart rear legs 18 and 20. The legs form a conventional A-structure frame wherein the front legs 14 and 16 are separated by rungs, or steps 22. The rear legs 18 and 20 are separated by stabilizing crossbars 24 spaced-apart along the length of the legs 18 and 20. A pair of locking members 26, 28 extend between the legs 14, 18, and 16, 20 respectively.

The ladder 12 has a top step 30 that usually forms a platform for placing brushes, fasteners, hammers, and other small tools for easy access for the user. The manufactures of stepladders instruct the users that the top step is not strong enough to support the weight of person and should not be used in climbing the ladder. Additionally, the top step 30 is usually small; it is often inadequate for retaining all the tools and accessories necessary for performing a certain task. Small objects, such as nuts, fasteners, and the like tend to roll off the top step 30, which will require the user or helper to bring them up again.

The tool box 10 of the first embodiment of the present invention has a housing means comprising a first housing portion 40, a second housing portion 42 and a central portion 44. The portions 40 and 42 form open top housings which extend below the top shelf 30 and can be of any desired depth for retaining the tools and equipment necessary to perform the job in a particular environment. For instance, the vertical dimension of the housing portions 40 and 42 can be 5-10 inches, depending on the particular design. The length of the vertical walls 46 defining the housings 40 and 42 can be 5 to 10 inches in length. Of course, these dimensions can be easily modified if necessary. The horizontal dimensions of the housings 40 and 42 can also be adapted for a specific task. For instance, the length of the horizontal walls 48 can be 5-10 inches, depending on a particular design. The housings 40 and 42 can be formed as square housings, oblong, or in any desired shape to accommodate the manufacturing and job-specific requirements.

The central portion 44 is configured to rest on the top shelf 30. In many aspects, the size of the central portion 44 depends on the dimensions of the top shelf 30. The central portion 44 comprises a flat top plate 50 provided with a peripheral lip, or upwardly extending flange 52. The top plate 50 is recessed below a top edge of the central portion 44 to allow to form a barrier, which prevents small objects from rolling from the top plate 50 when the toolbox 10 is in use. A handle 54 is secured to the plate 50. The handle 54 folds down and can be raised up by moving the handle 54 about hinged attachment members 56, 58, which secure the handle 54 to the plate 50.

It is envisioned that the central portion 44 can be smaller than the width of the horizontal walls 48 of the housing portions 40 and 42. The central portion 44 can be formed to closely approximate the dimensions of the top step 30 or extend slightly outside. It is sufficient that a large portion of the top plate 50 rests on the top step 30 for stability of positioning of the toolbox 10 on the ladder 12.

The housing portions 40 and 42 are each provided with a closed bottom 60, 62, respectively. The closed bottoms facilitate retaining of the equipment and tools in an easily accessible manner. A rear side 64 of the central portion 44 can be formed in general alignment with the rear walls 68, 70 of the housing portions 40 and 42, while the front wall 51 can be recessed in relation to the front walls 72, 74 of the housing portions 40 and 42 respectively.

If desired, an optional brush/tool tray 80 can be provided for use with the ladder 12. The tray 80 can be positioned adjacent the top step 30 and inserted between the top step 30 and the upper step in an easily accessible manner for the user. A roller brush or small object, nails, screws, etc. can be positioned in the tray to provide additional compartments for use of the worker on the ladder.

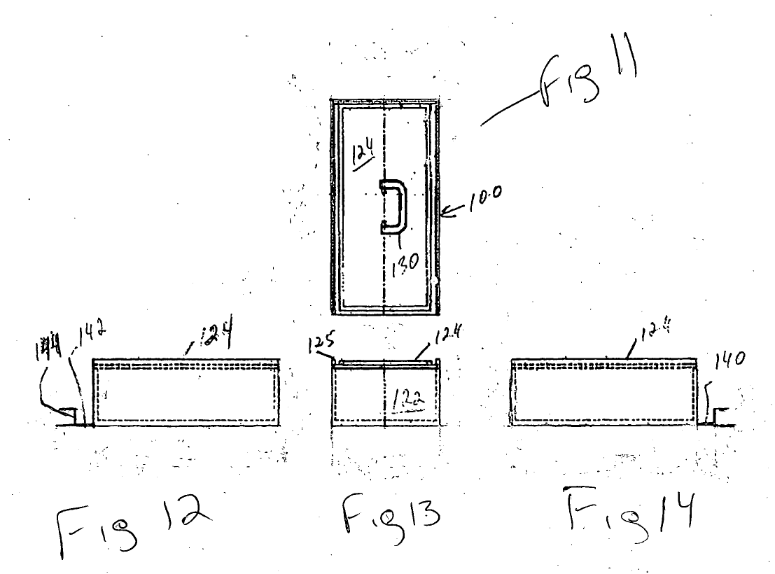

Turning now to the second embodiment of the present invention illustrated in FIGS. 7 through 14, the tool box 100 of the second embodiment is shown in use with a foldable stepladder 112. As can be seen in the drawings, the tool box 100 comprises a box-like enclosure having a closed bottom 114 and vertical walls 116, 118, 120, and 122. A top plate, or cover 124 is provided for covering the open top of the tool box 100. A pair of sliding grooves 126 are formed adjacent the top edges of the side walls 116 and 120 allowing the cover 124 to slide within the grooves to completely enclose the interior chamber defined by the tool box 100 or when moved back—allow access to the interior of the enclosure. The cover 124 is provided with a foldable handle 130 which can be folded down or raised up along hinges 132 secured to the top of the cover surface 124. A peripheral lip, or ledge 125 is formed about the walls 116, 118 and 120. The lip 125 prevents the small objects placed on the cover 124 from rolling off the toolbox 100.

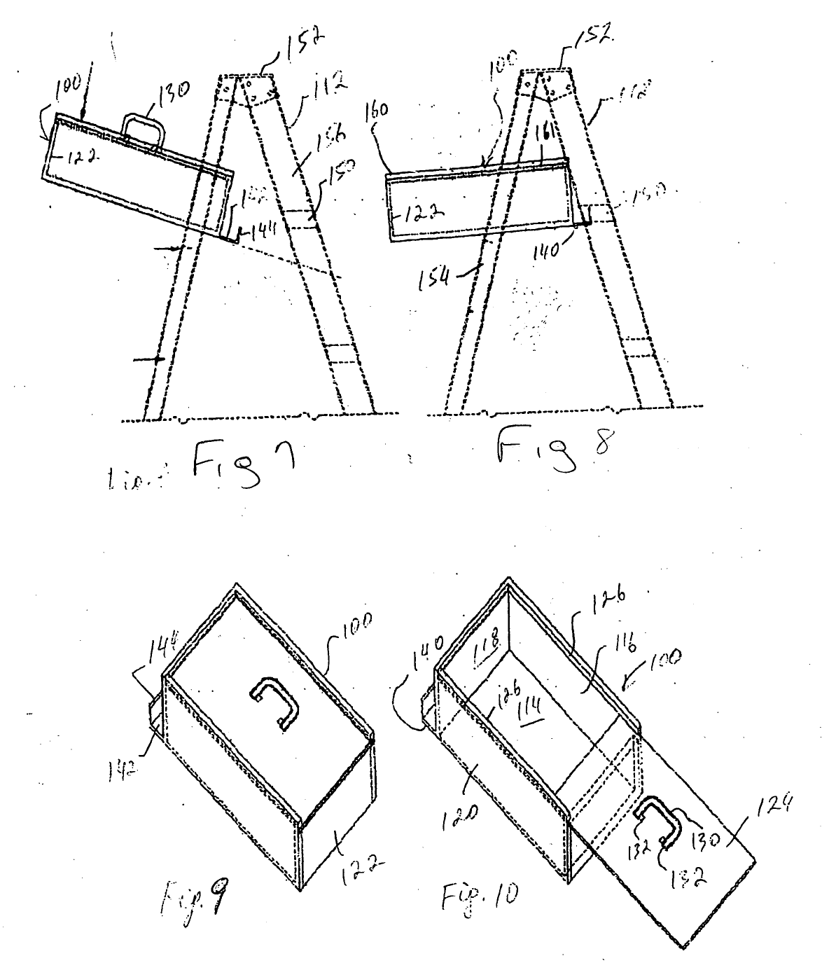

A hook shaped bracket 140 is secured along the wall 118. The bracket 140 comprises a securing member having an L-shaped cross section and comprising a horizontal portion 142 and a vertically extending portion 144. The height of the walls 116, 118, 120 and 122 can be adapted to allow the tool box 100 to fit between the ladder legs, and between an upper step 150 and a top step 152 of the ladder 112. The bracket 144 is dimensioned to hook to the underside of the upper step 150 in a manner shown in FIG. 8. The horizontal dimensions of the walls, 116, 118, 120 and 122 can be selected to allow at least a portion of the tool box 100 to extend outwardly from the back legs 154 of the ladder 112.

When positioning the tool box 100, the user moves the tool box to a position between the stabilizing members (not shown) secured to the back legs 154 towards the front legs 156, above the level of the horizontal brace or cross bar 24, as shown in FIGS. 1 and 7. The toolbox 100 is dimensioned such that the securing bracket 140, when hooked onto the step 150 of the ladder 112, supports the weight of the toolbox 100 and retains it in a cantilevered position on the ladder 112. When in a working position shown in FIG. 8, a front end 160 is oriented slightly below the back end 161, sloping downwardly to keep the weight of the cantilevered toolbox 100 stable.

Both tool boxes 10 and 100 can be easily transported to a desired job site by carrying them by handles 54 and 130. If desired, the tool boxes 10 and 100 can be used separately without the ladders 12 and 112. The tool boxes 10 and 100 can be simply positioned next to the job location, resting on their bottom surfaces 60, 62 and 114 while the user accesses the tools and accessories housed within the housing portions 40, 42 and within the tool box 100. If desired, the tool boxes 10 and 100 can be divided into a plurality of separate compartments to facilitate organizing the objects placed in the compartment. The tool boxes 10 and 100 can be made from inexpensive materials, such as molded plastic, plywood, lightweight metal, and the like.

Many changes and modifications can be made in the design of the present invention without department from the spirit thereof. I, therefore, pray that my rights to the present invention be limited only by the scope of the appended claims.

I claim:

1. A toolbox mountable on a ladder having a pair of parallel front legs, a pair of parallel back legs, a top step, and an upper step located below the top step, the tool box comprising:
a housing means for retaining auxiliary accessories, said housing means comprising a top plate, said top plate being recessed in relation to a top edge of the housing means to thereby define a peripheral lip formed about the top edge of the housing means.

2. The toolbox of claim 1, further comprising a carrying handle pivotally secured to said top plate.

3. The toolbox of claim 1, wherein the housing means comprises a first housing portion and a second housing portion secured on opposite side of the top plate.

4. The toolbox of claim 1, wherein the top plate is configured to rest on the top step of the ladder.

5. The toolbox of claim 3, wherein the first housing portion and the second housing portion is each configured to be suspended on opposite sides of the top plate.

6. The toolbox of claim 3, wherein the first housing portion and the second housing portion are each provided with an inner vertical wall secured to respective sides of the top plate, each of said inner walls being configured to extend downwardly from said top plate along legs of the ladder.

7. The toolbox of claim 3, wherein the first housing portion and the second housing portion is each provided with a closed bottom and an open top.

8. The toolbox of claim 1, wherein said housing means comprises a container having a closed bottom and an open top, and wherein the top plate forms a cover for covering the open top.

9. The toolbox of claim 8, wherein said container has a pair of opposing side walls, and wherein a groove is formed in each of said side walls below the top edge for slidably detachably receiving the cover therein.

10. The toolbox of claim 8, further comprising an engagement bracket secured to a bottom of said container.

11. The toolbox of claim 10, wherein said engagement bracket has a generally L-shaped cross-section.

12. The toolbox of claim 10, wherein said engagement bracket is configured for engaging the upper step of said ladder.

13. The toolbox of claim 10, wherein said container is sized and shaped to be cantilevered between the upper step and the top step of the ladder.

14. The toolbox of claim 13, wherein said container further comprises a front wall and a rear wall, and wherein said front wall is oriented below the rear wall when the container is secured on the ladder.

15. The toolbox of claim 1, further comprising a secondary container configured for positioning on said ladder below said housing means.

16. A toolbox mountable on a ladder having a pair of parallel front legs, a pair of parallel back legs, a top step, and an upper step located below the top step, the tool box comprising:
a housing means for retaining auxiliary accessories, said housing means comprising a top plate with a foldable handle, a first housing portion and a second housing portion, said top plate being recessed in relation to a top edge of the housing means to thereby define a peripheral lip formed about the top edge of the housing means, and wherein the the first housing portion and the second housing portion are each secured on opposite sides of the top plate.

17. The toolbox of claim 16, wherein the first housing portion and the second housing portion are each provided with an inner vertical wall secured to respective sides of the top plate, each of said inner walls being configured to extend downwardly from said top plate along legs of the ladder.

18. The toolbox of claim 16, wherein the top plate is configured to rest on the top step of the ladder.

19. A toolbox mountable on a ladder having a pair of parallel front legs, a pair of parallel back legs, a top step, and an upper step located below the top step, the tool box comprising:
a housing with an open top and a closed bottom,
a slidable cover recessed in relation to a top edge of the housing, the top edge of the housing defining a peripheral lip extending above the cover; and
a generally hook-shaped securing member for securing the housing to an upper step of the ladder below the top step.

20. The toolbox of claim 19, further comprising a handle pivotally secured on said cover.
